(19) United States
(12) Patent Application Publication
(10) Pub. No.: US 2017/0024731 A1
(43) Pub. Date: Jan. 26, 2017

(54) Systems and Methods for Dynamic Account Routing

(71) Applicant: Green Dot Corporation, Pasadena, CA (US)

(72) Inventors: David Gullett, Pasadena, CA (US); Anthony Peculic, Pasadena, CA (US)

(73) Assignee: Green Dot Corporation

(21) Appl. No.: 14/806,459

(22) Filed: Jul. 22, 2015

(51) Int. Cl. G06Q 20/40

(52) U.S. Cl. CPC G06Q 20/40

(57) ABSTRACT

Systems and methods for dynamic account routing in accordance with embodiments of the invention are disclosed. In one embodiment, a method for dynamic account routing includes obtaining requested transaction data using an account servicing server system where the requested transaction data identifies a consumer account and includes transaction amount data, identifying a set of routing rules based on the identified consumer account using the account servicing server system, requesting funds from at least one funding source system based on the set of routing rules using the account servicing system, where the requested funds are based on the transaction amount data, obtaining authorization data for the requested funds from the at least one funding source system using the account servicing server system, generating transaction authorization data based on the obtained authorization data and the requested transaction data using the account servicing server system, and providing the transaction authorization data.

### FIELD OF THE INVENTION

The present disclosure relates generally to financial services systems, and relates, more particularly, to processing transactions.

### BACKGROUND

The financial services industry provides a plethora of financial services to consumers for managing their finances and engaging in financial transactions with retailers and service providers. Consumers may hold funds within many different types of accounts at many different types of financial institutions. Consumers may access the funds held in the accounts using many different types of cards, including credit cards, debit cards, gift cards, and other types of cards based on the particular type of account associated with the card. The cards may be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors can verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for dynamic account routing in accordance with embodiments of the invention are disclosed. In one embodiment, a method for dynamic account routing includes obtaining requested transaction data using an account servicing server system, where the requested transaction data identifies a consumer account and includes transaction amount data and the account servicing server system includes a processor and a memory, identifying a set of routing rules based on the identified consumer account using the account servicing server system, requesting funds from at least one funding source system based on the set of routing rules using the account servicing system, where the requested funds are based on the transaction amount data, obtaining authorization data for the requested funds from the at least one funding source system using the account servicing server system, generating transaction authorization data based on the obtained authorization data and the requested transaction data using the account servicing server system, and providing the transaction authorization data using the account servicing server system.

In an additional embodiment, the routing rules include determining that the identified consumer account includes a trusted consumer account using the account servicing server system and providing the transaction authorization data prior to obtaining authorization data for the requested funds from the at least one funding source system using the account servicing server system.

In another embodiment of the invention, the routing rules include determining that the requested transaction data identifies a health savings account transaction and the selected funding source system includes a health savings account system.

In yet another additional embodiment of the invention, the routing rules include determining that a first funding source identified in the routing rule data is unavailable using the account servicing server system, utilizing local balance data for the first funding source to determine the first funding source can provide the requested funds using the account servicing server system, and providing the transaction authorization data prior to obtaining authorization data for the requested funds from the at least one funding source system using the account servicing server system.

In still another additional embodiment of the invention, the requested transaction data includes location data identifying the location where the transaction is occurring, the routing rules further include identifying a local currency associated with the location where the transaction is occurring using the account servicing server system, and the requested funds are requested in the local currency using the account servicing server system.

In yet still another additional embodiment of the invention, the obtained authorization data for the requested funds from the at least one funding source system indicates that the authorized amount is less than the requested funds and the method further includes determining that the consumer account is eligible for a loan using the account servicing server system, calculating the loan amount using the account servicing server system, requesting the loan in the loan amount using the account servicing server system, and utilizing the requested loan and the obtained authorization data to provide authorization for the requested transaction data using the account servicing server system.

In yet another embodiment of the invention, the routing rules include identifying rewards data for each of the at least one funding source systems using the account servicing server system, where the rewards data includes rewards amount data and category data for each funding source system, determining transaction category data for the requested transaction data using the account servicing server system, identifying a piece of rewards data based on the transaction category data and the category data using the account servicing server system, and requesting funds from the funding source system associated with the identified piece of rewards data using the account servicing server system.

In still another embodiment of the invention, the requested transaction data is obtained from a payment processor system and the transaction authorization data is provided to the payment processor system.

In yet still another embodiment of the invention, requesting funds from at least one funding source system further includes identifying balance data for each of the at least one funding source system using the account servicing server system, requesting a first portion of the requested funds from a first funding source system in the at least one funding source system based on the balance data for the first funding source system using the account servicing server system, and requesting a second portion of the request funds from a second funding source system in the at least one funding source system based on the balance data for the second funding source system and the first portion of the requested funds using the account servicing server system.

In yet another additional embodiment of the invention, requesting funds from at least one funding source system further includes requesting funds identified in the transaction data from a first funding source in the at least one funding source using the account servicing server system, requesting funds identified in the transaction data from a second funding source in the at least one funding source using the account servicing server system, obtaining a first authorization data from the first funding source for a second portion of the requested funds using the account servicing server system, obtaining a second authorization data from the second funding source for a second portion of the requested funds using the account servicing server system, calculating the authorized amount based on the first authorization data and the second authorization data using the account servicing server system, determining that the authorized amount exceeds the requested funds using the account servicing server system, adjusting the first authorization data based on the authorized amount and the routing rule data using the account servicing server system, adjusting the second authorization data based on the authorized amount and the routing rule data using the account servicing server system, providing the adjusted first authorization data to the first funding source system using the account servicing server system, and providing the adjusted second authorization data to the second funding source system using the account servicing server system.

Still another embodiment of the invention includes an account servicing server system including a processor and a memory connected to the processor and storing an account servicing server application, wherein the account servicing server application directs the processor to obtain requested transaction data where the requested transaction data identifies a consumer account and includes transaction amount data, identify a set of routing rules based on the identified consumer account, request funds from at least one funding source system based on the set of routing rules, where the requested funds are based on the transaction amount data, obtaining authorization data for the requested funds from the at least one funding source system, generating transaction authorization data based on the obtained authorization data and the requested transaction data, and providing the transaction authorization data.

In yet another embodiment of the invention, the routing rules include determining that the identified consumer account includes a trusted consumer account and providing the transaction authorization data prior to obtaining authorization data for the requested funds from the at least one funding source system.

In still another additional embodiment of the invention, the routing rules include determining that the requested transaction data identifies a health savings account transaction and the selected funding source system includes a health savings account system.

In yet still another embodiment of the invention, the routing rules include determining that a first funding source identified in the routing rule data is unavailable, utilizing local balance data for the first funding source to determine the first funding source can provide the requested funds, and providing the transaction authorization data prior to obtaining authorization data for the requested funds from the at least one funding source system.

In yet another additional embodiment of the invention, the requested transaction data includes location data identifying the location where the transaction is occurring, the routing rules further include identifying a local currency associated with the location where the transaction is occurring, and the requested funds are requested in the local currency.

In still another additional embodiment of the invention, the obtained authorization data for the requested funds from the at least one funding source system indicates that the authorized amount is less than the requested funds and the account servicing application further directs the processor to determine that the consumer account is eligible for a loan, calculate the loan amount, request the loan in the loan amount, and utilize the requested loan and the obtained authorization data to provide authorization for the requested transaction data.

In yet still another additional embodiment of the invention, the routing rules include identifying rewards data for each of the at least one funding source systems, where the rewards data includes rewards amount data and category data for each funding source system, determining transaction category data for the requested transaction data, identifying a piece of rewards data based on the transaction category data and the category data, and requesting funds from the funding source system associated with the identified piece of rewards data.

In yet another embodiment of the invention, the requested transaction data is obtained from a payment processor system and the transaction authorization data is provided to the payment processor system.

In still another embodiment of the invention, the account servicing application directs the processor to request funds from at least one funding source system by identifying balance data for each of the at least one funding source system, requesting a first portion of the requested funds from a first funding source system in the at least one funding source system based on the balance data for the first funding source system, and requesting a second portion of the request funds from a second funding source system in the at least one funding source system based on the balance data for the second funding source system and the first portion of the requested funds.

In yet still another embodiment of the invention, the account servicing application directs the processor to request funds from at least one funding source system by requesting funds identified in the transaction data from a first funding source in the at least one funding source, requesting funds identified in the transaction data from a second funding source in the at least one funding source, obtaining a first authorization data from the first funding source for a second portion of the requested funds, obtaining a second authorization data from the second funding source for a second portion of the requested funds, calculating the authorized amount based on the first authorization data and the second authorization data, determining that the authorized amount exceeds the requested funds, adjusting the first authorization data based on the authorized amount and the routing rule data, adjusting the second authorization data based on the authorized amount and the routing rule data, providing the adjusted first authorization data to the first funding source system, and providing the adjusted second authorization data to the second funding source system.

### BRIEF DESCRIPTION OF THE DRAWINGS

FIG. 1A is a conceptual illustration of an account servicing system in accordance with an embodiment of the invention.

FIG. 1B is a conceptual illustration of a request routing interface provided by an account servicing server system in accordance with an embodiment of the invention.

FIG. 2 is a conceptual illustration of an account servicing server system in accordance with an embodiment of the invention.

FIG. 3A is a flow chart illustrating a process for authorizing a transaction in accordance with an embodiment of the invention.

FIG. 3B is a flow chart illustrating a process for authorizing a transaction with parallel funding requests in accordance with an embodiment of the invention.

FIG. 4 is a flow chart illustrating a process for obtaining fund authorizations in accordance with an embodiment of the invention.

FIG. 5 is a flow chart illustrating a process for providing transaction notifications in accordance with an embodiment of the invention.

FIGS. 6A-F are flow charts illustrating processes for routing fund requests in accordance with an embodiment of the invention.

FIG. 7 is a flow chart illustrating a process for loading funds into an account in accordance with an embodiment of the invention.

### DETAILED DESCRIPTION

Turning now to the drawings, systems and methods for banking platform isolation in accordance with embodiments of the invention are disclosed. Prepaid accounts allow consumer accounts to easily have access to funds that have been deposited to their prepaid account without the overhead of a traditional financial institution. Funds can be loaded onto consumer accounts associated with the prepaid card (i.e. a prepaid card account) at a variety of participating locations, such as retailers. These funds can be loaded onto a prepaid card (i.e. deposited into the consumer account associated with the prepaid card) through various mechanisms, including direct deposit, check deposit, wire transfers, online deposits, cash deposits, and any other techniques as applicable to the requirements of specific embodiments of the invention. Consumers can then use the prepaid cards in a manner similar to traditional debit and/or credit cards to purchase products using the funds that have been loaded onto the account.

In accordance with embodiments of the invention, account servicing server systems can provide a dynamic payment routing service to consumer accounts and to users of prepaid cards. In a variety of embodiments, one or more funding accounts can be associated with a consumer account. The consumer account can also include a variety of routing rules describing how transactions should be fulfilled (i.e. how the requested payment amount is to be provided) from the account balance associated with the consumer account and/or the funding accounts. In several embodiments, account servicing server systems can track funds available in each funding account and determine the appropriate funding account to use to fulfill a transaction accordingly. Furthermore, the routing of payments can be utilized in foreign transactions (e.g. those occurring in foreign countries to the home country of the consumer account and/or those transactions utilizing a currency that is not associated with the consumer account) in several embodiments of the invention. Metadata describing the funding sources can be included in the consumer account and utilized to determine which funding source(s) should be utilized for a particular transaction. Funding sources can include, but are not limited to, debit card accounts, credit card accounts, prepaid cards, closed-loop accounts, checking accounts, savings accounts, and any other account capable of holding and providing funds as appropriate to the requirements of specific applications of embodiments of the invention. In many embodiments, the funding accounts are serviced by third-party funding sources (i.e. provided by funding source systems and/or financial institution systems) that are separate and distinct from the account servicing server system servicing the consumer account. A variety of routing rules can be utilized as appropriate to the requirements of specific applications of embodiments of the invention as described in further detail herein. Notifications can be provided to a consumer account, such as those displayed on client devices, and contain information related to which funding sources have been utilized to fulfill particular transactions.

By way of example, a customer can take a prepaid card into a retail and select a variety of goods for purchase. The customer takes the goods to the point of sale terminal and the clerk scans the goods. The point of sale terminal generates a transaction request and the consumer selects their prepaid card to pay for the transaction. The transaction request data and the prepaid card account data are transmitted to a payment processor system associated with the prepaid card account. The payment processor system provides the prepaid card account data and the transaction data to an account servicing server system for approval. The account servicing server system access the account identified by the prepaid card account data and identifies a routing rule that indicates that goods from the retailer should be paid for with a credit card having a favorable rewards program for that retailer, with any excess funds necessary to be taken from a checking account. Both the credit card account and the checking account are described in funding source data associated with the consumer account. The account servicing server system requests an authorization for the amount of the transaction from the credit card account funding source and the checking account funding source. The credit card account funding source authorizes all but $50 of the proposed transaction, while the checking account funding source authorizes $100. The account servicing server system can then request $50 from the checking account and the remaining funds from the credit card account funding source. The account servicing server system can then provide an affirmative response authorizing the transaction to proceed. The point of sale system indicates that the transaction was successful and the consumer purchases the goods. A notification is then sent to the consumer's mobile phone, informing the consumer that their credit card and checking account were used to fund the transaction.

Account servicing systems in accordance with a variety of embodiments of the invention include account servicing server systems that can communicate with consumer systems and isolate those communications from payment processor systems and/or financial institution systems. Consumer systems include point of sale systems, client devices, retailer systems, and any other system that can be utilized to obtain and/or display data regarding a consumer account as appropriate to the requirements of specific applications of embodiments of the invention. Account servicing systems can abstract and isolate payment processor systems and/or financial institution systems from the account servicing server system utilizing a banking platform interface. The banking platform interface can allow an account servicing server system to seamlessly communicate with multiple payment processor systems and/or financial institution systems by translating internal command data to payment processor system (and/or financial institution system) command data. The banking platform interface allows for the dynamic routing of communication between consumer systems, account servicing server systems, and payment processor systems and/or financial institution systems. Additionally, the account servicing system can then automatically prepare (and/or translate) data provided as part of the services to command data that is utilized by payment processor systems to execute the requested services. In a variety of embodiments, a payment processor system identifies a consumer account using processor account identifier data. The same consumer account can also be identified by an account servicing server system using account identifier data. Using the banking platform interface, the account servicing server system can dynamically map account identifier data and processor account identifier data in order to identify particular consumer accounts. Systems and methods for providing banking platform interfaces that can be utilized in accordance with embodiments of the invention are described in U.S. patent application Ser. No. 14/718,811, titled “Systems and Methods for Banking Platform Isolation” and filed May 21, 2015.

In many embodiments, account servicing systems can detect account activity and target advertising to client devices associated with the active accounts based on location information associated with or implied by the account transactions (e.g. the location of a point of sale terminal and/or a client device at the time of the transaction), available account balances, and/or available funding sources. In this way, the account servicing systems allow advertisers to programmatically target advertisements based on the location of a consumer and the funds available to the consumer account. In several embodiments, the account servicing systems directly target advertising to consumer accounts and/or client devices associated with consumer accounts. In a number of embodiments, the account servicing systems provide account identification data identifying consumer accounts and/or client devices associated with consumer accounts as targets to advertising networks that target advertisements to the identified consumer accounts. In accordance with the requirements of specific applications of embodiments of the invention, advertising data includes one or more offers that can be redeemed by a consumer account. Offers can include, but are not limited to, offers that can be redeemed to obtain a discount on particular goods and/or result in a credit to the consumer account's account. In a variety of embodiments, advertising data includes a set of offers, where an offer includes a mapping between a particular product and a discount to be applied to the purchase of that product. That is, advertising data can include a set of mappings between product data describing products and offer data describing offers applicable to the products. Account servicing systems can analyze a consumer account's financial transactions and apply offers to the consumer account's account and/or transactions based on transactions that satisfy the criteria of previously presented (and/or accepted) offers presented to the consumer account. In this way, account servicing systems can facilitate the redemption of offers associated with advertising presented to consumer accounts, thereby encouraging consumer accounts to shop at particular retailers. Systems and methods for targeting advertising that can be utilized in accordance with embodiments of the invention are described in U.S. patent application Ser. No. 14/587,945, titled “Systems and Methods for Targeting Advertising to Prepaid Card Accounts” and filed Dec. 31, 2014.

As described in more detail below, funding sources can include a loan extended to a consumer account. In a number of embodiments, account servicing systems can automatically determine fraud in transactions and additionally potentially extending loans to particular prepaid card account. By extending a loan to these consumer accounts, prepaid cards can be utilized to complete these transactions even when insufficient funds are able to be obtained from the funding sources. Any of a variety of loans can be extended in accordance with the requirements of specific applications of the invention including, but not limited to, unsecured loans, secured loans, and installment (e.g. closed-ended) loans. The particular loan product(s) extended to a consumer account can depend on any of a variety of factors such as, but not limited to, the amount of the loan offered, the amount of security associated with the consumer account, the recency of the last loan offered, accepted, and/or paid off by the consumer account, the amount of loans previously offered and/or outstanding, the products being purchased, demographic information describing the consumer account, the balance history of the account, and any other data as appropriate to the requirements of specific applications of embodiments of the invention. In particular, loans can be offered when prepaid cards are utilized to purchase goods at both brick and mortar retail locations and online marketplaces. Systems and methods for determining fraud and/or loan underwriting and for transmitting request data and/or authorization data to payment processor systems that can be utilized in accordance with embodiments of the invention are described in U.S. patent application Ser. No. 14/699,753, titled “Systems and Methods for Loan Underwriting for Prepaid Accounts” and filed Apr. 29, 2015.

The disclosures of U.S. patent application Ser. Nos. 14/587,945, 14/699,753, and 14/718,811 are hereby incorporated by reference in their entirety.

It should be noted, however, that a consumer account need not have any funds available to dynamically route payments in accordance with embodiments of the invention. Additionally, a variety of consumer accounts in accordance with embodiments of the invention are not associated with a prepaid card. These prepaid cards (and/or consumer accounts) can be known as routing cards (and/or routing accounts) and allow consumer accounts to link a variety of funding sources to the routing cards and then utilize the routing cards as a single payment method to dynamically draw funds from the linked funding sources. Any reference to prepaid cards herein also includes utilizing routing cards to effect similar systems and/or processes. Additionally, in many embodiments of the invention, one or more of the funding sources can be serviced by the same account servicing server system that services the consumer account. Systems and processes for dynamic account routing in accordance with embodiments of the invention are described in more detail below.

### Account Servicing Systems

Conducting financial transactions can involve communication between many different parties (e.g., banks, processors, credit issuers, regulators, consumers, etc. . . . ) prior to funds being exchanged between a consumer and a retailer (i.e. between a consumer account and the retailer's account). For example, a consumer account may initiate a purchase at a point-of-sale terminal of a retailer. The retailer system may track certain information for the consumer account, including the items being purchased and the total purchase price and may send this information to a payment processor system. An account servicing server system can utilize a variety of funding sources in order to fulfill the purchase price before and/or after sending the information to the payment processor system. In turn, the payment processor system can communicate with a multitude of financial institution systems in order to process the transaction.

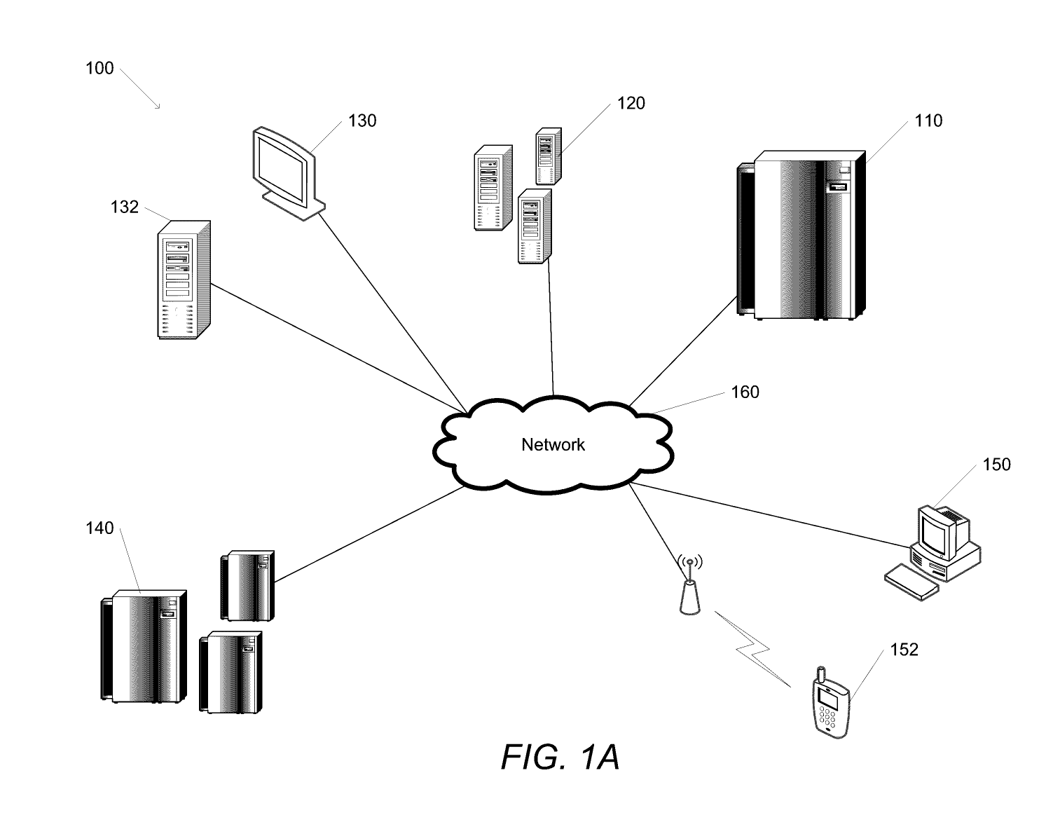

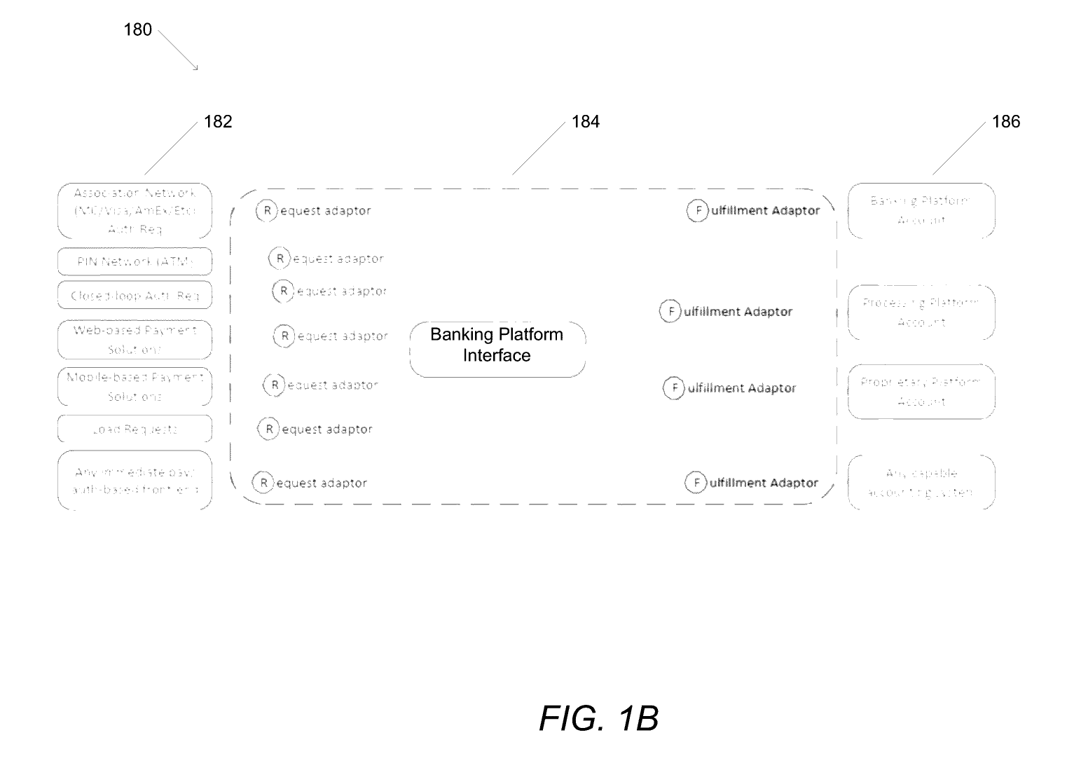

Turning now to FIG. 1, a conceptual illustration of an account servicing system in accordance with an embodiment of the invention is shown. The account servicing system 100 includes account processing server system 110, payment processor systems 120, retailer systems such as point of sale terminals 130 and retailer server system 132, financial institution systems 140, and client devices including, but not limited to, personal computers 150 and mobile devices 152. In many embodiments, the retailer systems 130, financial institution systems 140, and/or account processing server system 110 can host the accounts associated with a variety of funding sources. It should be noted that any reference to a funding source herein also includes the funding source system hosting the account associated with the funding source.

These systems can communicate through one or more networks 160. Network(s) 160 can include, but are not limited to, the Internet, a local area network, a wide area network, and networks that are shared privately between only a subset of the systems. For example, the payment processor 120 can communicate with the financial institution systems 140, retailer systems, and account servicing server system 110 via one or more private networks.

Account servicing server system 110 can provide front-end and back-end services for creating and managing consumer accounts via a number of account servicing processes as appropriate to the requirements of specific applications of embodiments of the invention. Account servicing server system 110 can obtain account data for a prepaid card and/or a variety of funding sources from a retailer system and/or from a client device. The account servicing server system 110 can assign the consumer account to a payment processor system 120 and/or financial institution system 140. A request that a permanent card (such as a prepaid card or a routing card) be issued to the account holder associated with the account by the payment processor system 120 and/or financial institution system 140 can also be made. The account servicing server system 110 can also communicate with financial institution systems 140 and/or the payment processor systems 120 to facilitate the execution of transactions between consumer accounts, funding sources, and retailer systems when the transaction involves the prepaid card. This can include storing a variety of data obtained from the payment processor systems 120, financial institution systems 140, and/or retailer systems and using the stored data to provide account servicing processes. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide an interface providing account data, user profile data, balance data, transaction data, fee data, and any other data related to the prepaid card and/or the consumer account as appropriate to the requirements of specific applications of embodiments of the invention. In many embodiments, the consumer account is provided funds (cash, check, direct deposit, etc. . . . ) from a point of sale terminal at a retailer along with a prepaid card. The retailer system can then transmit transaction data specifying the amount of funds to be added to the consumer account associated with the prepaid card to an account servicing server system, a payment processor system, and/or a financial institution system as appropriate to the requirements of specific applications of embodiments of the invention. The funds can be loaded to the prepaid card account and/or provided to one or more funding sources as appropriate to the requirements of specific applications of embodiments of the invention. If necessary, the account servicing server system 110 can provide a mapping between account identification data identifying the consumer account and processor account identification data.

When a transaction is executed (and/or requested to be executed), the account servicing server system 110 can obtain requested transaction data describing the transaction, including the amount to be debited as a result of the transaction and/or the status (i.e. approved, denied) of the transaction. By way of example, processor request data (i.e. transaction data) can be transmitted by a payment processor system 120 and/or a retailer system. The account servicing server system 110 can determine one or more funding sources to be utilized to fulfill the transaction. The account servicing server system 110 can then notify the payment processor system that a transaction has been presented and allowed without providing direct access to the funding sources. In this way, the account servicing server system 110 can facilitate the purchase of products using prepaid cards by utilizing a variety of funding sources and/or by automatically granting loans in order to facilitate a transaction. In this way, the account servicing server system 110 can abstract the authorization of transactions from obtaining the funds necessary to fulfill the transaction. In several embodiments, the account servicing server system 110 provides pre-authorization data to the payment processor system so that the transaction is not denied before obtaining the necessary funds from the funding sources.

Retailer systems, such as point of sale terminal 130, can be used to purchase prepaid cards, load fund onto the prepaid cards, as well as process transactions that use a prepaid card associated with a consumer account to make purchases of products and/or services from the retailer. The point of sale terminal 130 can transmit transaction data describing the requested transaction to the retailer server system 132 and/or the processor system 120. In many embodiments, the point of sale terminal 130 communicates directly with the account servicing server system 110. In a variety of embodiments, the retailer server system 132 obtains transaction data from a number of point of sale terminals 130 and transmits the transaction data utilizing techniques similar to those described above. In many embodiments, the account servicing server system 110 stores data obtained from the retailer systems and/or associates the obtained data with particular consumer accounts.

Payment processor systems 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards for a particular consumer account. Payment processor systems 120 provide a transaction interface that can be utilized to process transaction data. The transaction data can be obtained from any system, including the retailer systems. The payment processor system 120 can process data in real-time, on a set schedule, and/or in batch as appropriate to the requirements of specific applications of embodiments of the invention. In a number of embodiments, the payment processor system 120 processes transactions for prepaid cards (or any other account) issued by (or otherwise associated with) the payment processor system 120. In a variety of embodiments, the payment processor system 120 provides a bill payment service between one or more consumer accounts. Processing transaction data includes determining if a transaction should be authorized. In several embodiments, the transaction data includes transaction amount data describing the requested value of the transaction. Authorizing a transaction can include determining if the requested value is less than the balance of the consumer account. In several embodiments, the balance of the consumer account is based on the funds authorized to be drawn from one or more funding sources. If a transaction is authorized, funds drawn from an account associated with the prepaid card are directed to be transferred to an account associated with the retailer identified in the transaction. The transfer of funds can include transmitting requests to one or more financial institution systems 140 and/or the account servicing server system 110 in order to execute the requested transaction. In several embodiments, if the transaction is not authorized, the payment processor system 120 can request additional information from the account servicing server system 110. This additional information can then be utilized to re-process the transaction, potentially resulting in the transaction being authorized. In a variety of embodiments, payment processor systems 120 provide one or more account servicing interfaces to communicate with the account servicing server system 110 and/or financial institution system 140. The account servicing interface can be utilized by the account servicing server system 110 to obtain and/or transmit data to and from the payment processor system 120. For example, if the payment processor system 120 needs additional information in order to process a transaction, that information can be requested and obtained from the account servicing server system 110 and/or the financial institution system 140. However, it should be noted that any processes that include communication between the payment processor system 120 and other systems within the account servicing system 100 can utilize the account servicing interface as appropriate to the requirements of specific embodiments of the invention.

Financial institution systems 140 include financial accounts for one or more entities. These financial accounts hold funds on behalf of the entities and can transfer the funds to retailer systems, payment processors, account servicing server systems, or any other system as appropriate to the requirements of specific applications of embodiments of the invention. In many embodiments, financial institution systems 140 incorporate some or all aspects of the payment processor systems 120. In this way, financial institution systems can issue, service, and/or approve transactions for consumer accounts related to prepaid cards.

Client devices can be used to manage account data associated with prepaid cards, purchase cards, add (e.g. reload) or remove funds from cards, purchase products from a retailer, request and/or accept loans, manage funding sources, view and configure routing rules, and any other transactions or operations as appropriate to the requirements of specific applications of embodiments of the invention. Furthermore, client devices can be utilized to request loans for particular consumer accounts. The account servicing server systems 110 can provide account data, balance data, transaction data, routing rule data, funding source data, and/or any other appropriate data to the client devices based on processor request data and/or processor transaction data stored using the account servicing server system 110. In this way, the data and services provided to the client devices can be isolated from the payment processor systems 120 facilitating the services. This can allow consumer accounts to be easily migrated from one payment processor system to another.

Turning now to FIG. 1B, a conceptual illustration of an application programming interface (API) that can be utilized to route requests by an account servicing server system within an account servicing system is shown. The API 180 includes a variety of request devices 182 requesting transaction authorizations, a banking platform interface 184, and a set of funding sources 186 capable of funding a particular transactions. The request devices 182 can include any of a variety of systems and platforms that request authorization in order to complete a transaction, such as credit card processor systems, closed-loop retailer systems (i.e. store gift cards), and third-party payment processors, such as the PayPal service provided by PayPal Inc. of San Jose, Calif. The funding sources 186 can authorization requests respond with response data indicating success, failure, and/or a partial fulfillment of the request. The banking platform interface 184 can include a variety of incoming request adaptor interfaces and a variety of outgoing fulfillment adaptor interfaces. These interfaces allow transactions to be received from the request devices 182 to be obtained in a format native to the request devices and translate those requests into a format understood by the funding sources 186. Systems and methods that can be utilized to obtain and translate requests and responses are described in U.S. patent application Ser. No. 14/718,811, incorporated by reference above. As is described in more detail below, the banking platform interface 184 can also utilize a variety of routing rules to dynamically map requests to one or more funding sources.

Although a specific architecture of an account servicing system in accordance with embodiments of the invention are discussed above, a variety of architectures, including client devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs) web services, and/or file-based interfaces not specifically described herein) as appropriate to the requirements of specific applications of embodiments of the invention.

### Account Servicing Server Systems

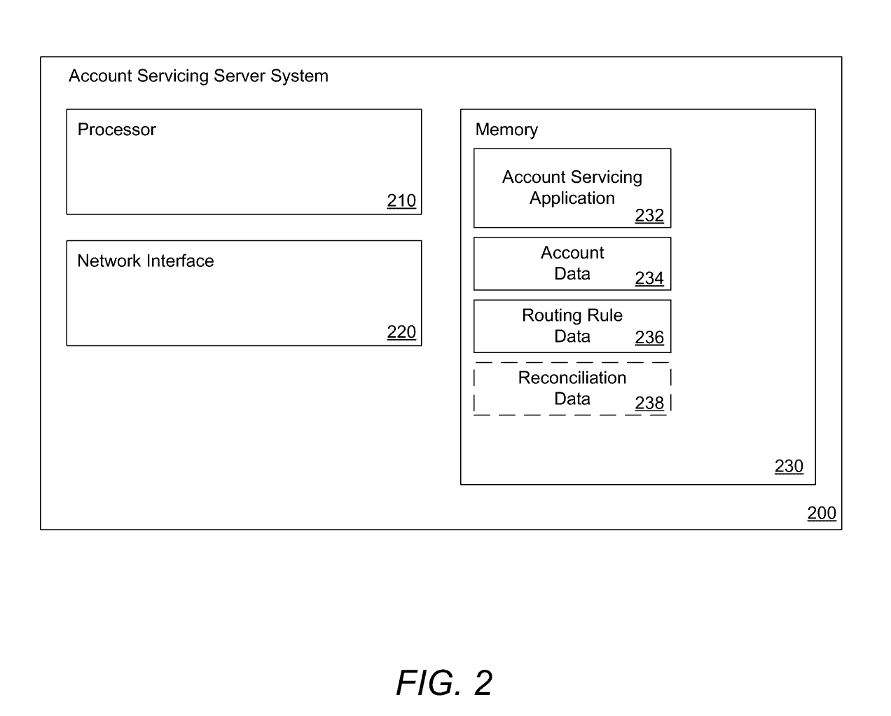

As described above, account servicing server systems can provide a variety of services for consumer accounts associated with prepaid cards. These services can include maintaining a database of funding sources and routing rules and dynamically determining which funding sources should be utilized to fulfill a particular transaction based on the routing rules. An account servicing server system in accordance with an embodiment of the invention is conceptually illustrated in FIG. 2. The account servicing server system 200 includes a processor 210 in communication with a network interface 220 and a memory 230. The network interface 220 is capable of sending and receiving data over a network connection. In a number of embodiments, the network interface 220 is in communication with the memory 230. In several embodiments, memory 230 is any form of storage configured to store a variety of data, including, but not limited to, an account servicing application 232, account data 234, routing rule data 236, and, in several embodiments, reconciliation data 238.

The account servicing application directs the processor 210 to perform a variety of account servicing processes. The account servicing processes include processing financial transactions for a consumer account, including reconciliation of debits and credits applied to a consumer account. The account servicing processes can also include managing account data 234 describing the consumer account including, but not limited to, reload activity, balance activity, and location data, consumer account profile data, demographic data, employment information, credit status, income, mailing address, and/or any other consumer account pertinent information. Account data 234 can include data received from a variety of different sources, including client devices, retailer systems, payment processor systems, financial institution systems, and any other of a variety of other sources. Account data 234 can also include metadata describing one or more funding sources associated with a consumer account. This metadata can include, but is not limited to, account numbers, current balances, available credit, rewards program information, currency information, and location data (such as what country the funding source is located in or countries to which the funding source will provide funds). The account data can also be related to routing rule data 236. Routing rule data 236 includes a variety of rules for mapping requests for funds to a variety of funding sources. Specific examples of routing rules that can be described using the routing rule data 236 are illustrated in detail below. In a variety of embodiments, account servicing processes can include extending a loan to a consumer account when insufficient funds can be obtained from the funding sources.

Additionally, the account data 234 can be related to reconciliation data 238. In many embodiments, account servicing processes include authorizing a transaction prior to obtaining funds from one or more funding sources. In a number of embodiments, account servicing processes include determining when a transaction has been overfunded and requesting lower funding amounts from one or more funding sources. Reconciliation data 238 can include metadata describing the cost associated with particular transactions and/or the funds provided by one or more funding sources. This metadata can be utilized to request a particular amount of funds from a particular funding source and/or request a particular amount of credit be applied to a particular funding source as appropriate to the requirements of specific embodiments of the invention. Additionally, reconciliation data 238 can include metadata utilized to verify that particular transactions have been approved and/or denied along with verification that funds have been successfully obtained from the appropriate funding sources for each transaction. Systems and methods for utilizing reconciliation data to reconcile transactions executed using account servicing server systems that can be utilized in accordance with embodiments of the invention are described in U.S. patent application Ser. No. 14/718,811, incorporated by reference above.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 230 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. A variety of account servicing processes in accordance with embodiments of the invention are discussed further below.

### Authorizing Transactions

Once a consumer account is linked to one or more funding sources, any of a variety of account servicing processes can be utilized to fund transactions using the funding sources in accordance with embodiments of the invention. When a transaction associated with a consumer account is requested, requested transaction data can be generated that describes a variety of properties of the transaction. The requested transaction data can include, but is not limited to, the identification of the retailer at which the transaction is occurring, the location of the retailer, the currency associated with the transaction, metadata identifying the goods being purchased (i.e. shopping cart data), category data for the goods and/or retailer, the total cost of the transaction, and the consumer account associated with the prepaid card utilized to complete the transaction. Funds can be requested to cover the cost of the transaction. The funds can be obtained from any of the funding sources and/or a balance associated with the prepaid card can be utilized to pay for the transaction. If a first funding source cannot provide the entire requested amount, one or more supplemental funding sources can be queried to provide the remaining balance. If the funding sources and/or local balance can provide sufficient funds, authorization data can be created for the requested transaction data. In several embodiments, the requested transaction data is generated by a retailer system and transmitted to a payment processor system. In many embodiments, the authorization data is transmitted to a payment processor system, which then provides final authorization to the retailer system. In a number of embodiments, the requested transaction data and/or authorization data are provided to/sent from the account servicing server system directly.

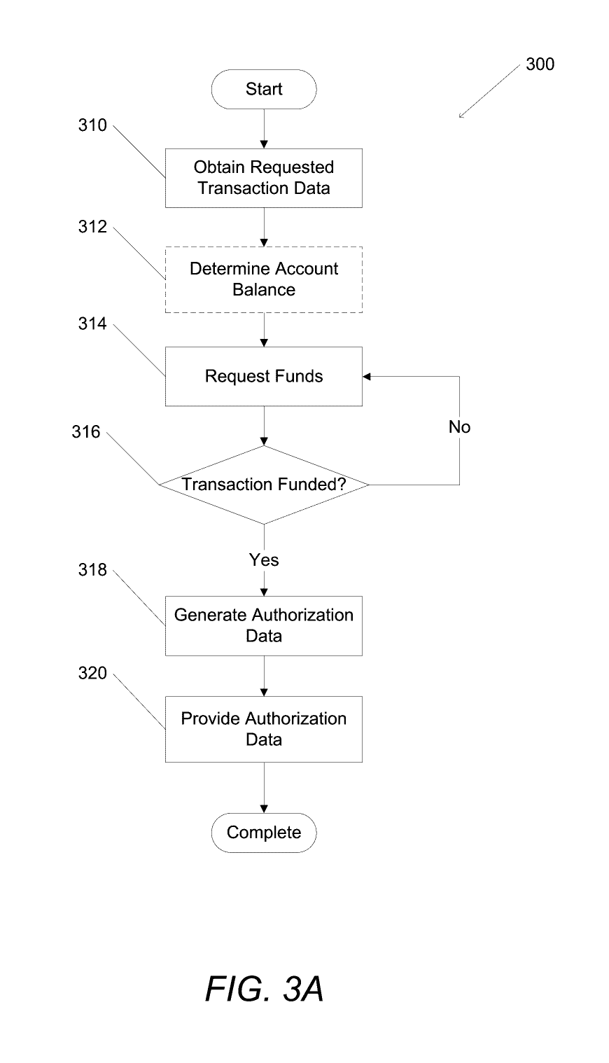

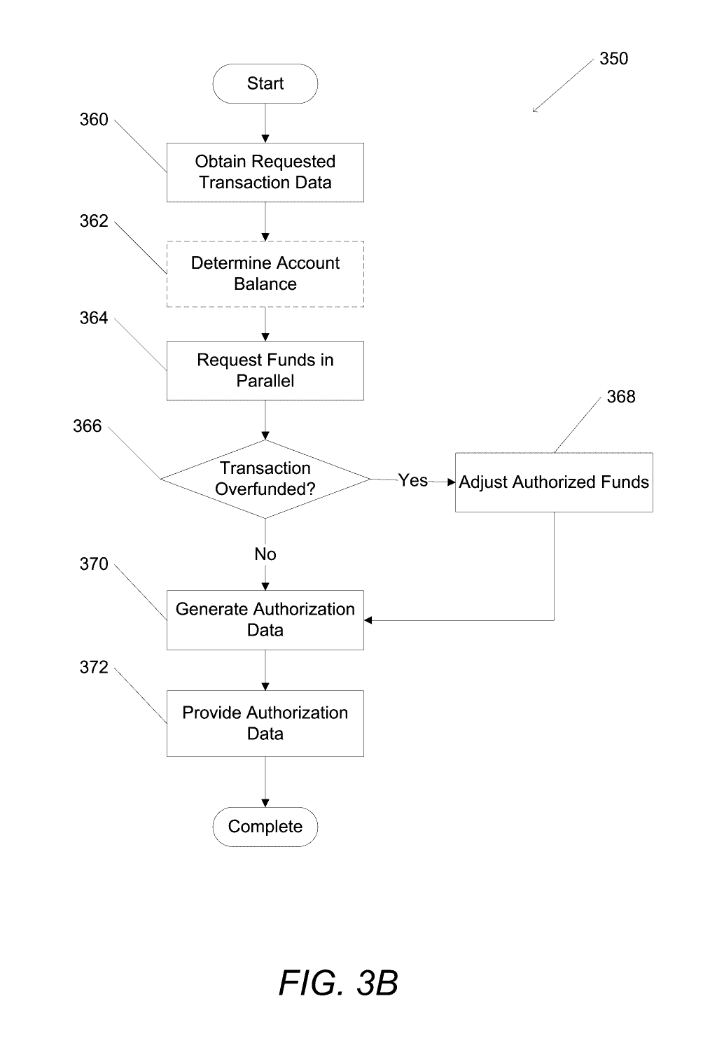

A process for authorizing transactions in accordance with embodiments of the invention is shown in FIG. 3A. The process 300 includes obtaining (310) requested transaction data and, in several embodiments, determining (312) account balances. Funds are requested (314) and, if the transaction is not funded (316), additional funds are requested (316). When the transaction is funded (316), authorization data is generated (318) and provided (320).

In addition to querying funding sources sequentially until a sufficient amount of funds can be obtained, funds can be requested from funding sources in parallel. That is, requests for the full amount of the requested transaction data can be transmitted to one or more of the funding sources at the same time. In this case, each queried funding source can provide authorizations indicating how much of the requested funds the funding source can provide. In the event that the requested transaction would be overfunded, one or more of the provided authorizations can be adjusted so that the excess funds are either returned or not obtained from the funding sources. The amount of the adjustment, if any, can be determined according to the routing rule data associated with the particular requested transaction data as appropriate to the requirements of specific applications of embodiments of the invention. In a variety of embodiments, this parallel authorization of a transaction can reduce the latency between obtaining the requested transaction data and providing authorization data to allow the transaction to proceed.

Turning now to FIG. 3B, a process for authorizing transactions in parallel is shown. The process 350 includes obtaining (360) requested transaction data and, in several embodiments, determining (362) account balances. Funds are requested (364) in parallel and, if the transaction is overfunded (366), the authorized funds are adjusted (368). Authorization data is generated (370) and provided (372).

Specific processes for authorizing transactions in accordance with embodiments of the invention are described above; however, any of a variety of processes, including those with payment processor systems utilizing alternative techniques to those described above, can be utilized as appropriate to the requirements of specific applications in accordance with embodiments of the invention.

### Obtaining Funding Authorizations

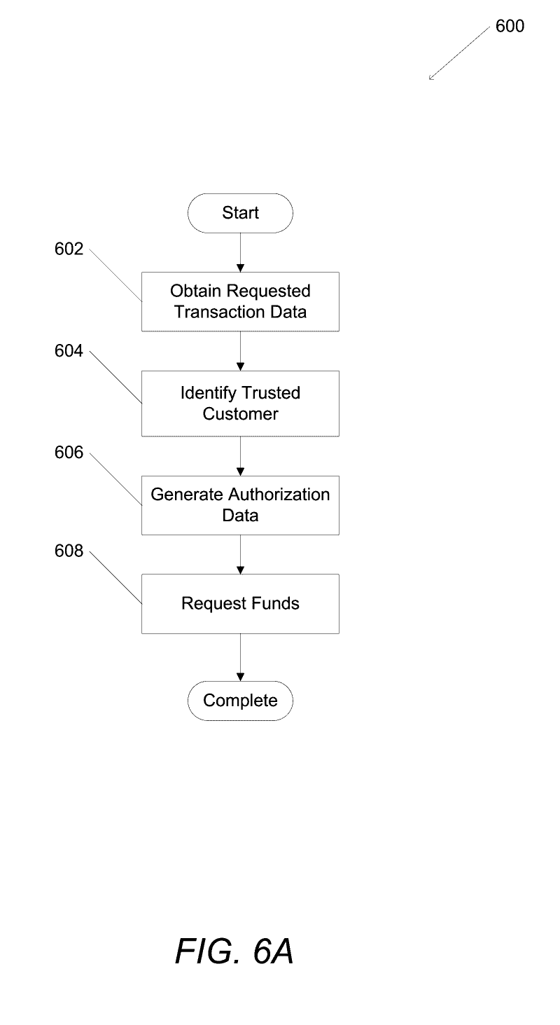

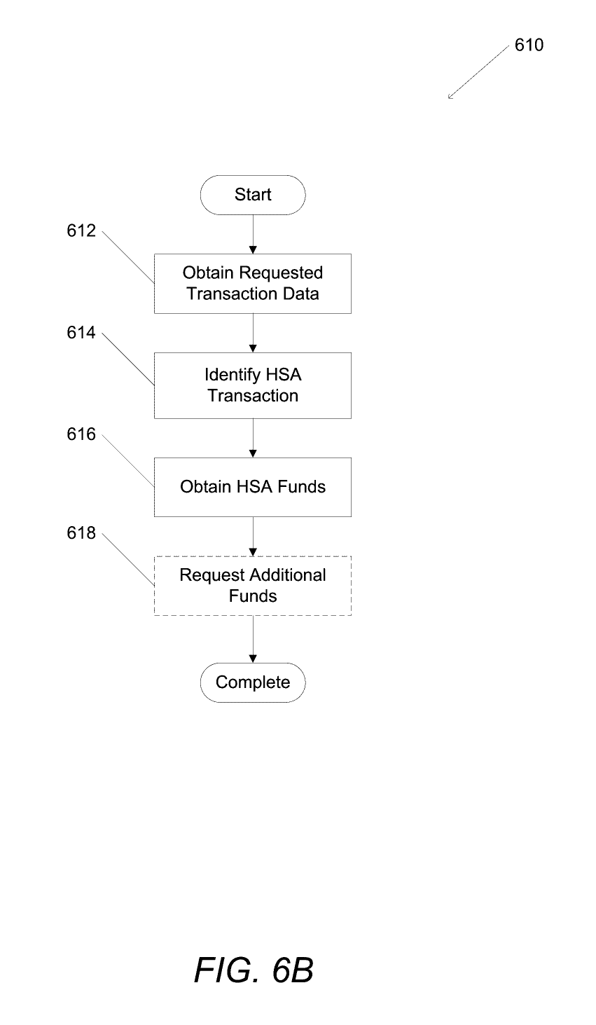

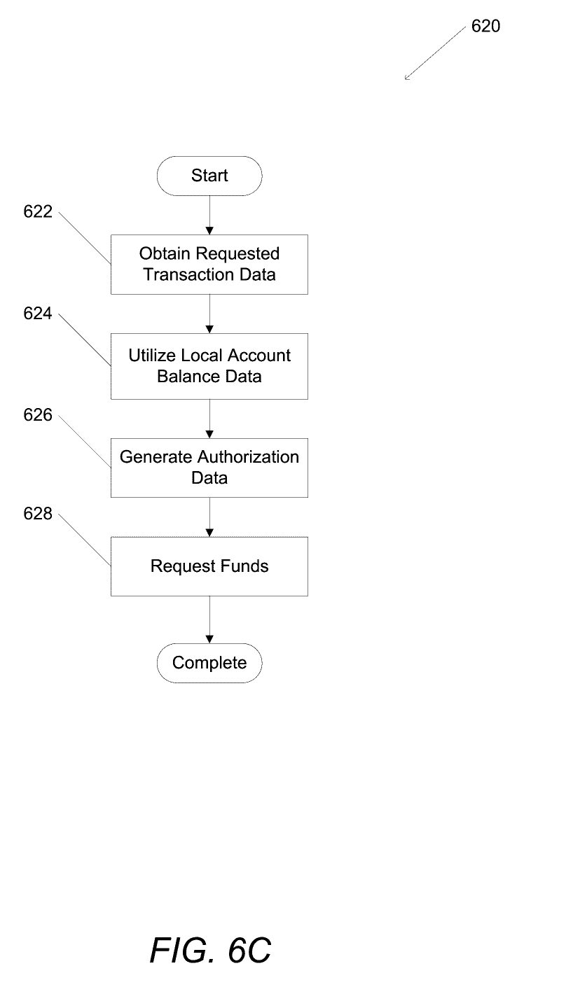

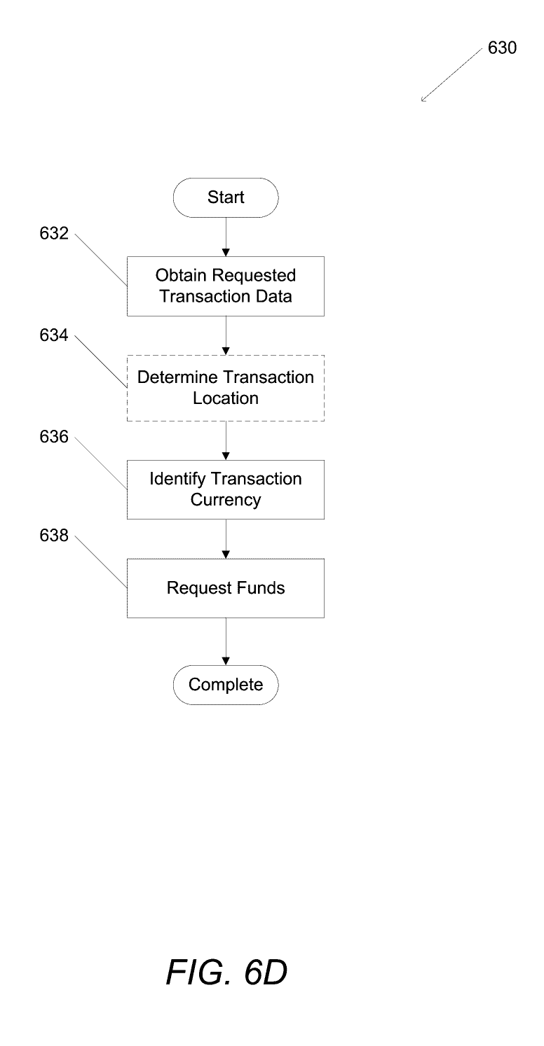

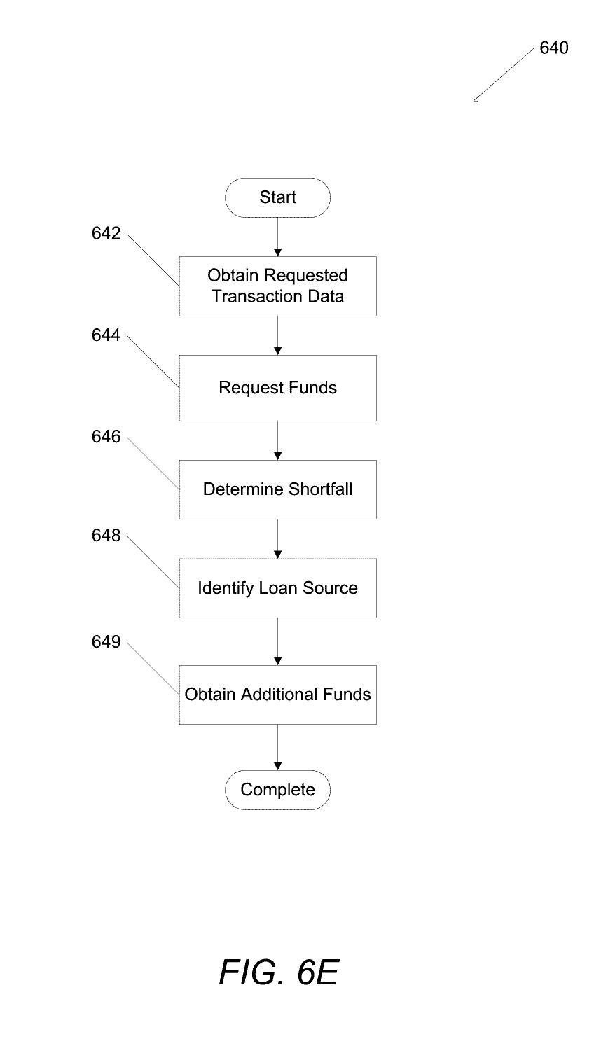

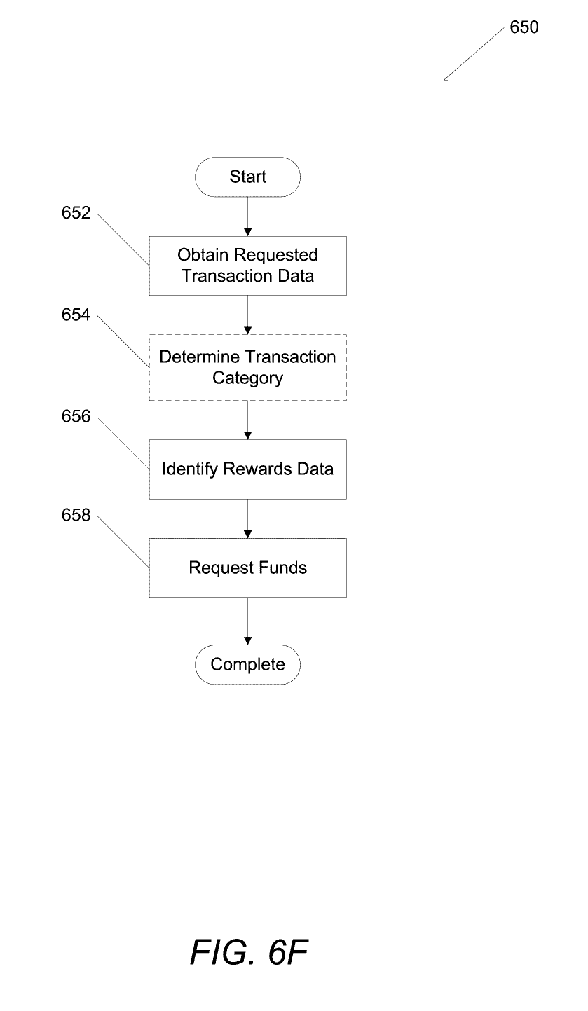

Account servicing process in accordance with embodiments of the invention can include using a variety of routing rules to dynamically determine which funding sources can be utilized to fund a particular transaction. As described above, a variety of properties of a transaction can be identified in the requested transaction data generated for a particular transaction. These properties can be utilized to select one or more rules described in the routing rule data. A variety of rules that can be utilized in accordance with embodiments of the invention are describe in more detail with respect to FIGS. 6A-F below. Once the appropriate rules have been selected, fund request data can be generated for each of the funding sources selected based on the routing rule data. The fund request data can be transmitted to the funding source systems and the funding source systems can respond with fund authorization data. The fund request data can include any of a variety of data, such as the amount of funds requested, the identity of the funding source, the funding account associated with the funding source, and any other data as appropriate to the requirements of specific applications of embodiments of the invention. The fund authorization data can include the amount of the funds described in the fund request data that the funding source will provide. In the event that insufficient funds are provided by a funding source, additional funds can be drawn from alternative funding sources. In the event that insufficient funds can be obtained, the transaction may fail unless alternative funds, such as a loan or additional cash provided at the transaction location, can be obtained.

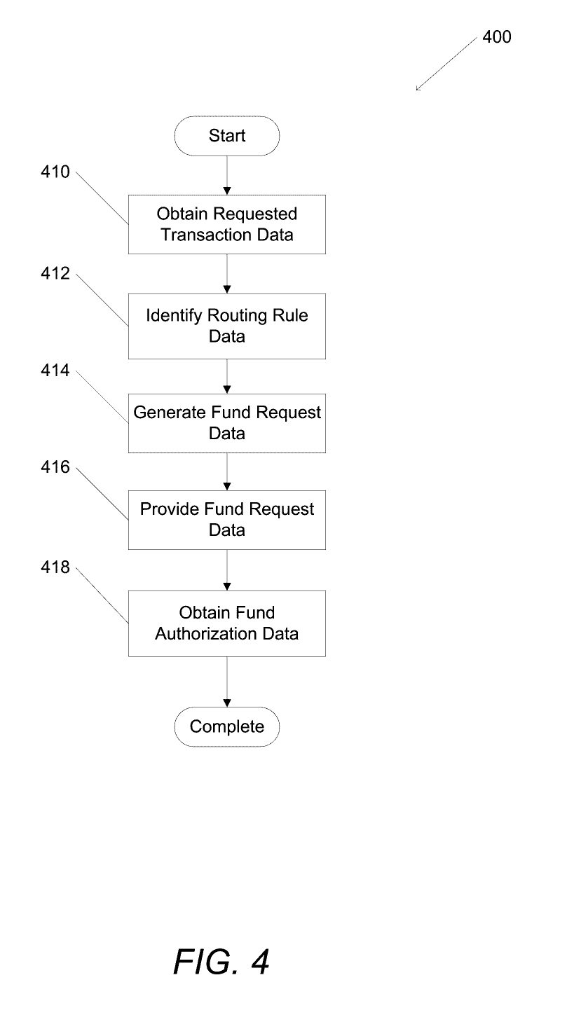

A process for obtaining funding authorizations in accordance with embodiments of the invention is shown in FIG. 4. The process 400 includes obtaining (410) fund request data, identifying (412) routing rule data, generating (414) fund request data, providing (416) fund request data, and obtaining (418) fund authorization data.

Processes for obtaining funding authorizations in accordance with embodiments of the invention are described above. However, any of a variety of processes, including those that obtain authorizations using techniques other than those specifically described above, can be utilized as appropriate to the requirements of specific applications in accordance with embodiments of the invention.

### Providing Notifications

Account servicing processes can include providing a variety of notifications regarding the execution of transactions. In many embodiments, a requested transaction can be obtained and a routing rule selected to determine the funding sources to be utilized to fund the transaction. In several embodiments, notification data describing the routing rule and/or funding sources can be generated. This notification data can include the specific transaction, the routing rule utilized, the funding sources selected, the funds to be provided by each funding source, and/or any other data as appropriate to the requirements of specific applications of embodiments of the invention. The notification data can include transaction feedback data; the transaction feedback data can be utilized to provide a final approval to an account servicing server system before authorizing the transaction and obtaining the funds from the indicated funding sources. Notification data can also be generated that includes a summary of the transaction once the transaction has been authorized similar to that described above. The transaction feedback data can also include updates to the funding sources and/or routing rule data as appropriate to the requirements of specific applications of embodiments of the invention.

Notification data can be transmitted to and/or displayed by a variety of devices. Point-of-sale terminals and/or kiosks at the retailers can obtain and display the notification data to consumers during the transaction. Similarly, the notification data can be transmitted to and/or displayed by a client device associated with the consumer account. The notifications can be pushed in real time, requested on a schedule and/or on demand, or provided in any other way as appropriate to the requirements of specific applications of embodiments of the invention.

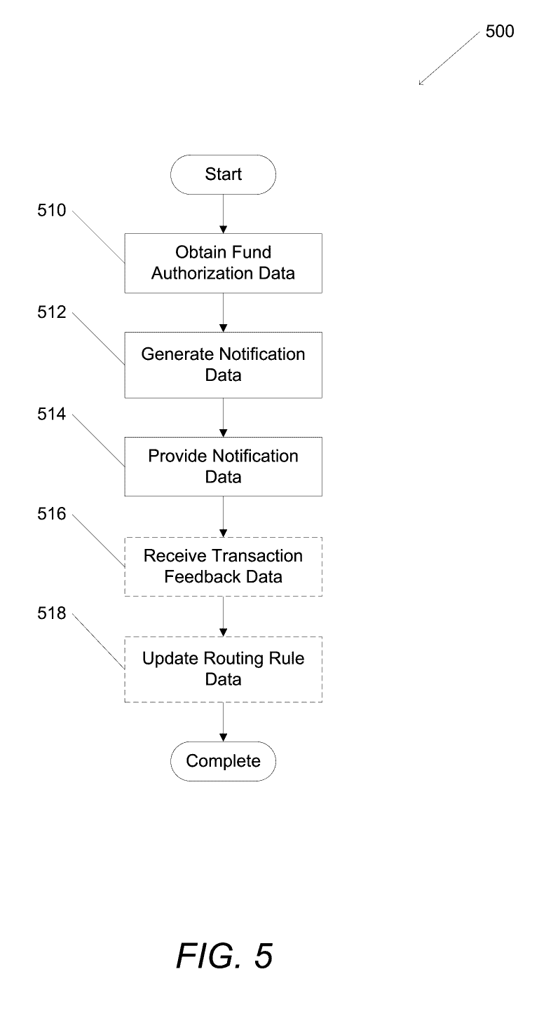

A process for providing notifications in accordance with embodiments of the invention is shown in FIG. 5. The process 500 includes obtaining (510) fund authorization data, generating (512) notification data and providing (514) notification data. In a number of embodiments, transaction feedback data is received (516) and routing rule data is updated (518).

Specific processes for providing notifications in accordance with embodiments of the invention are described above; however, any of a variety of processes, including those that provide notifications to devices other than client devices, can also be utilized as appropriate to the requirements of specific applications in accordance with embodiments of the invention.

### Routing Fund Requests

As describe above, a variety of account servicing processes include identifying and utilizing routing rule data to dynamically fund transactions by dynamically routing funding requests. A variety of routing rule data can be employed in these processes. In several embodiments, routing rule data includes determining when a consumer account is a trusted consumer account. One of the benefits of having a trusted consumer account can include automatically authorizing transactions, such as those below a particular funding amount or those occurring in particular locations, in order to facilitate the checkout process for the consumer. The account servicing processes can then include obtaining the necessary funding authorizations from the funding sources at a later time. A trusted consumer account can be indicated in a variety of ways, such as by using a trust score associated with the consumer account. Based on one or more threshold values, various levels of trust can be assigned to a particular consumer account. These trust levels can be utilized to determine if and when transactions can be automatically authorized. Systems and methods for determining trust scores for consumer accounts that can be utilized as appropriate to the requirements of specific applications of embodiments of the invention are described in U.S. patent application Ser. No. 14/699,753, incorporated by reference above. Trusted consumer accounts can also be associated with particular properties of the consumer account. For example, if the consumer account is associated with a closed-loop transaction for a particular retailer (i.e. a gift card for a particular retailer is being utilized), the authorization can be automatically granted up to a certain amount, such as the amount associated with the gift card.

A process for funding requests from trusted accounts in accordance with embodiments of the invention is shown in FIG. 6A. The process 600 includes obtaining (602) requested transaction data, identifying (604) a trusted customer account, generating (606) authorization data, and requesting (608) funds.

Routing rules can include requesting funds from specialized accounts. One such type of special account is a health savings account (HSA). A HSA allows for consumers to contribute funds to the HSA without incurring income tax on those contributions. The HSA can be utilized to pay for certain goods, such as qualified medical expenses. In many embodiments, the requested transaction data identifies one or more products and/or services that can be paid for using a HSA. Routing rules can include identifying when such qualifying goods are present in a transaction, determining the value associated with those goods, and requesting the necessary funds from the HSA as the funding source utilized to pay for the qualifying goods. In several embodiments, a merchant category code (MCC) can be utilized to identifying qualifying goods, although any technique can be utilized to identify qualifying goods as appropriate to the requirements of specific applications of embodiments of the invention. In the event that the transaction includes non-qualifying goods, additional funds can be obtained from alternative funding sources. However, it should be noted that any of a variety of specially marked accounts, including tax-advantaged accounts like a HSA or savings accounts provided by an account servicing server system, can be utilized as appropriate to the requirements of specific applications of embodiments of the invention.

In several embodiments, account servicing server systems allow consumer accounts to identify particular goods that they wish to purchase. In many embodiments, the account servicing server systems facilitate the establishment of savings accounts for each of the identified goods. Funds that are loaded onto a prepaid card can then be allocated, either manually or automatically, to the savings account for a particular good. When a consumer account uses the prepaid card to purchase the identified good, the funds to purchase the good can then be taken from the savings account for that good. Account servicing systems can utilize a variety of data such as, but not limited to, demographic information regarding the consumer account, the prepaid card, and/or the identified goods, to provide targeting information to a variety of retailers and/or advertisers. In a variety of embodiments, the targeting information is utilized to target advertising to particular consumer accounts. By providing a consumer account with an advertisement and/or coupon, account servicing server systems can provide the consumer account with an offer at an opportune time that is particularly useful to the consumer account. In several embodiments, the savings account for a particular good are hosted by a third-party funding source system so that the savings account is serviced by a funding source system separate from the account servicing server system servicing the consumer account. Systems and methods for maintaining and utilizing savings accounts that can be utilized in accordance with embodiments of the invention are described in U.S. patent application Ser. No. 14/587,931, titled “Systems and Methods for Targeting Advertising Based on Future Purchases” and filed Dec. 31, 2014, the disclosure of which is hereby incorporated by reference in its entirety.

A process for funding requests for HSA transactions in accordance with embodiments of the invention is shown in FIG. 6B. The process 610 includes obtaining (612) requested transaction data, identifying (614) a HSA transaction, obtaining (616) HSA funds, and, if necessary, requesting (618) additional funds.

In several embodiments, account servicing server systems maintain balance data for one or more funding sources associated with a consumer account. In the event that a funding source identified in the routing rule data is unavailable for any reason, the locally stored balance data can be utilized to determine the likelihood that the funding source will authorize the requested funds. Based on the likelihood that the funds will be authorized, the authorization data can be generated prior to obtaining the authorization from the funding source. When the funding source becomes available, the funds can be requested. Systems and methods for maintaining balance data that can be utilized in accordance with a number of embodiments of the invention are described in U.S. patent application Ser. No. 14/718,811, incorporated by reference above.

A process for utilizing local account balance data to authorize transactions in accordance with embodiments of the invention is shown in FIG. 6C. The process 620 includes obtaining (622) requested transaction data, utilizing (624) local account balance data, generating (626) authorization data, and requesting (628) funds.

In many embodiments, a consumer account is generally associated with a particular currency, such as U.S. Dollars. However, a consumer may utilize their prepaid card for any of a variety of transactions, including those that are not conducted using the currency nominally associated with the consumer account. These transactions can occur at any location; in a number of embodiments, the location of the transaction is utilized to identify the currency utilized for a requested transactions. In other embodiments, the requested transaction data identifies the currency utilized in the transaction. The routing rule data can include identifying particular funding sources that should be utilized for transactions occurring in particular locations and/or in particular currencies. For example, particular funding sources may be located in particular countries, hold funds in a particular currency, or have advantageous policies (such as a low exchange rate) for conducting transactions in particular locations and/or currencies. In this way, funding requests and authorizations can be provided to and by the appropriate funding source.

A process for funding foreign transactions in accordance with embodiments of the invention is shown in FIG. 6D. The process 630 includes obtaining (632) requested transaction data and, in many embodiments, determining (634) transaction location data. The currency associated with the transaction is identified (636) and funds are requested (638).

In a variety of embodiments, the funding sources queried to authorize a particular transaction are unable to provide the necessary funds. In many embodiments, account servicing processes can include analyzing the consumer account and determining if the consumer account is eligible for a loan from one or more loan sources. The loans can be provided by the account servicing server system and/or third-party loan provider systems as appropriate to the requirements of specific applications of embodiments of the invention. Additional routing rules can be utilized to select a third-party loan provider system utilizing techniques similar those described herein. Any of a variety of criteria, such as interest rate, loan amount, and/or loan duration, can be utilized in accordance with embodiments of the invention. Systems and methods that can be utilized to authorize loans for consumer accounts that can be utilized in accordance with embodiments of the invention are described in U.S. patent application Ser. No. 14/699,753, incorporated by reference above. If a loan can be obtained, the loan amount plus any funds authorized by the funding sources can be utilized to authorize the requested transaction data.

A process for obtaining a loan to authorize a transaction in accordance with embodiments of the invention is shown in FIG. 6E. The process 640 includes obtaining (642) requested transaction data, requesting (644) funds, determining (646) that a shortfall exists, identifying (648) a loan source, and obtaining (649) additional funds.

In a number of embodiments, routing rules include identifying category data associated with the requested transaction data. The category data can be based on the retailer and/or on the specific goods described in the requested transaction data as appropriate to the requirements of specific applications of embodiments of the invention. Each funding source can also be associated with one or more categories, where the funding source provides particular rewards for spending in the identified categories. In many embodiments, rewards are based on particular goods rather than categories of goods or retailers. The routing rule data can include a description of which funding sources provide rewards for particular goods and/or categories and request funding from the appropriate funding sources for the requested transaction data in order to take advantage of the available rewards. These rewards can be any rewards provided by a funding source, including cash back, points, travel rewards, financing offers, or any other reward as appropriate to the requirements of specific applications of embodiments of the invention. In many embodiments, the rewards can be coupons or other offers provided by the account servicing server system. Systems and methods for providing offers to consumer accounts that can be utilized in accordance with embodiments of the invention are described in U.S. patent application Ser. No. 14/587,945, incorporated by reference above.

A process for selecting funding accounts based on rewards activity in accordance with embodiments of the invention is shown in FIG. 6F. The process 650 includes obtaining (652) requested transaction data and, in a variety of embodiments, determining (654) category data for the transaction. Rewards data is identified (656) and funds are requested (658).

Although specific processes for requesting funds in accordance with embodiments of the invention are described above, any of a variety of processes, including techniques not specifically described above and those that utilize different criteria in the routing requests, can be used as appropriate to the requirements of specific applications in accordance with embodiments of the invention. Additionally, it should be noted that any of the processes for requesting funds can be combined or otherwise blended to create compound routing rules in accordance with many embodiments of the invention.

### Loading Funds

In addition to locating funds to fulfill transactions, account servicing processes can also include loading funds onto a consumer account. The routing rule data can be utilized to determine which funding sources the loaded funds should be applied. The routing rule data can identify one or more funding source accounts and the amounts to be deposited to each funding source account. The amounts to be deposited can be fixed, a percentage of the loaded amount, and/or dynamically determined as appropriate to the requirements of specific applications of embodiments of the invention. Notification data can also be generated describing the deposits made to the particular funding source accounts selected based on the routing rule data. In several embodiments, account servicing processes include maintaining a local database of account balances (that is, independent of the funding sources themselves) and the local database can be updated based on the amount loaded onto each funding source account. In this way, the account balance associated with each funding source can be locally tracked, providing more ready access to the account balance data and providing a local source of data to reconcile particular transactions and/or account balances.

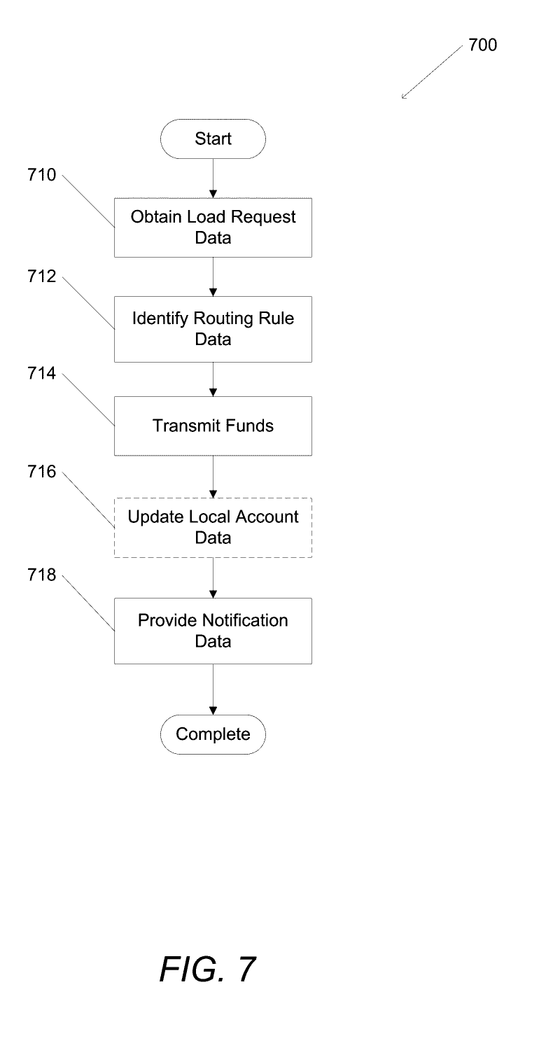

A process for loading funds in accordance with an embodiment of the invention is shown in FIG. 7. The process 700 includes obtaining (710) load request data, identifying (712) load request rules, transmitting (714) funds, and, in many embodiments, updating (716) local account data. Notification data is provided (718).

Specific process for loading funds in accordance with embodiments of the invention are described above. However, any of a variety of processes, including those that utilize alternative rules not specifically described above, can be utilized as appropriate to the requirements of specific applications in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for dynamic account routing, comprising:
obtaining requested transaction data using an account servicing server system, where:
the requested transaction data identifies a consumer account and comprises transaction amount data; and
the account servicing server system comprises a processor and a memory;
identifying a set of routing rules based on the identified consumer account using the account servicing server system;
requesting funds from at least one funding source system based on the set of routing rules using the account servicing system, where the requested funds are based on the transaction amount data;
obtaining authorization data for the requested funds from the at least one funding source system using the account servicing server system;
generating transaction authorization data based on the obtained authorization data and the requested transaction data using the account servicing server system; and
providing the transaction authorization data using the account servicing server system.

2. The method of claim 1, wherein the routing rules comprise:
determining that the identified consumer account comprises a trusted consumer account using the account servicing server system; and
providing the transaction authorization data prior to obtaining authorization data for the requested funds from the at least one funding source system using the account servicing server system.

3. The method of claim 1, wherein:
the routing rules comprise determining that the requested transaction data identifies a health savings account transaction; and
the selected funding source system comprises a health savings account system.

4. The method of claim 1, wherein the routing rules comprise:
determining that a first funding source identified in the routing rule data is unavailable using the account servicing server system;
utilizing local balance data for the first funding source to determine the first funding source can provide the requested funds using the account servicing server system; and
providing the transaction authorization data prior to obtaining authorization data for the requested funds from the at least one funding source system using the account servicing server system.

5. The method of claim 1, wherein:
the requested transaction data comprises location data identifying the location where the transaction is occurring;
the routing rules further comprise identifying a local currency associated with the location where the transaction is occurring using the account servicing server system; and
the requested funds are requested in the local currency using the account servicing server system.

6. The method of claim 1, wherein:
the obtained authorization data for the requested funds from the at least one funding source system indicates that the authorized amount is less than the requested funds; and
the method further comprises:
determining that the consumer account is eligible for a loan using the account servicing server system;
calculating the loan amount using the account servicing server system;
requesting the loan in the loan amount using the account servicing server system; and
utilizing the requested loan and the obtained authorization data to provide authorization for the requested transaction data using the account servicing server system.

7. The method of claim 1, wherein the routing rules comprise:
identifying rewards data for each of the at least one funding source systems using the account servicing server system, where the rewards data comprises rewards amount data and category data for each funding source system;
determining transaction category data for the requested transaction data using the account servicing server system;
identifying a piece of rewards data based on the transaction category data and the category data using the account servicing server system; and
requesting funds from the funding source system associated with the identified piece of rewards data using the account servicing server system.

8. The method of claim 1, wherein:
the requested transaction data is obtained from a payment processor system; and
the transaction authorization data is provided to the payment processor system.

9. The method of claim 1, wherein requesting funds from at least one funding source system further comprises:
identifying balance data for each of the at least one funding source system using the account servicing server system;
requesting a first portion of the requested funds from a first funding source system in the at least one funding source system based on the balance data for the first funding source system using the account servicing server system; and
requesting a second portion of the request funds from a second funding source system in the at least one funding source system based on the balance data for the second funding source system and the first portion of the requested funds using the account servicing server system.

10. The method of claim 1, wherein requesting funds from at least one funding source system further comprises:
requesting funds identified in the transaction data from a first funding source in the at least one funding source using the account servicing server system;
requesting funds identified in the transaction data from a second funding source in the at least one funding source using the account servicing server system;
obtaining a first authorization data from the first funding source for a second portion of the requested funds using the account servicing server system;
obtaining a second authorization data from the second funding source for a second portion of the requested funds using the account servicing server system;
calculating the authorized amount based on the first authorization data and the second authorization data using the account servicing server system;
determining that the authorized amount exceeds the requested funds using the account servicing server system;
adjusting the first authorization data based on the authorized amount and the routing rule data using the account servicing server system;
adjusting the second authorization data based on the authorized amount and the routing rule data using the account servicing server system;
providing the adjusted first authorization data to the first funding source system using the account servicing server system; and
providing the adjusted second authorization data to the second funding source system using the account servicing server system.

11. An account servicing server system, comprising:
a processor; and
a memory connected to the processor and storing an account servicing server application;
wherein the account servicing server application directs the processor to:
obtain requested transaction data where the requested transaction data identifies a consumer account and comprises transaction amount data;
identify a set of routing rules based on the identified consumer account;
request funds from at least one funding source system based on the set of routing rules, where the requested funds are based on the transaction amount data;
obtaining authorization data for the requested funds from the at least one funding source system;
generating transaction authorization data based on the obtained authorization data and the requested transaction data; and
providing the transaction authorization data.

12. The system of claim 11, wherein the routing rules comprise:
determining that the identified consumer account comprises a trusted consumer account; and
providing the transaction authorization data prior to obtaining authorization data for the requested funds from the at least one funding source system.

13. The system of claim 11, wherein:
the routing rules comprise determining that the requested transaction data identifies a health savings account transaction; and
the selected funding source system comprises a health savings account system.

14. The system of claim 11, wherein the routing rules comprise:
determining that a first funding source identified in the routing rule data is unavailable;
utilizing local balance data for the first funding source to determine the first funding source can provide the requested funds; and
providing the transaction authorization data prior to obtaining authorization data for the requested funds from the at least one funding source system.

15. The system of claim 11, wherein:
the requested transaction data comprises location data identifying the location where the transaction is occurring;
the routing rules further comprise identifying a local currency associated with the location where the transaction is occurring; and
the requested funds are requested in the local currency.

16. The system of claim 11, wherein:
the obtained authorization data for the requested funds from the at least one funding source system indicates that the authorized amount is less than the requested funds; and
the account servicing application further directs the processor to:
determine that the consumer account is eligible for a loan;
calculate the loan amount;
request the loan in the loan amount; and
utilize the requested loan and the obtained authorization data to provide authorization for the requested transaction data.

17. The system of claim 11, wherein the routing rules comprise:
identifying rewards data for each of the at least one funding source systems, where the rewards data comprises rewards amount data and category data for each funding source system;
determining transaction category data for the requested transaction data;
identifying a piece of rewards data based on the transaction category data and the category data; and
requesting funds from the funding source system associated with the identified piece of rewards data.

18. The system of claim 11, wherein:
the requested transaction data is obtained from a payment processor system; and
the transaction authorization data is provided to the payment processor system.

19. The system of claim 11, wherein the account servicing application directs the processor to request funds from at least one funding source system by:
identifying balance data for each of the at least one funding source system;
requesting a first portion of the requested funds from a first funding source system in the at least one funding source system based on the balance data for the first funding source system; and
requesting a second portion of the request funds from a second funding source system in the at least one funding source system based on the balance data for the second funding source system and the first portion of the requested funds.

20. The system of claim 11, wherein the account servicing application directs the processor to request funds from at least one funding source system by:
requesting funds identified in the transaction data from a first funding source in the at least one funding source;
requesting funds identified in the transaction data from a second funding source in the at least one funding source;
obtaining a first authorization data from the first funding source for a second portion of the requested funds;
obtaining a second authorization data from the second funding source for a second portion of the requested funds;
calculating the authorized amount based on the first authorization data and the second authorization data;
determining that the authorized amount exceeds the requested funds;
adjusting the first authorization data based on the authorized amount and the routing rule data;
adjusting the second authorization data based on the authorized amount and the routing rule data;
providing the adjusted first authorization data to the first funding source system; and
providing the adjusted second authorization data to the second funding source system.
